(19) United States
(12) Patent Application Publication
(10) Pub. No.: US 2024/0152148 A1
(43) Pub. Date: May 9, 2024

(54) SYSTEM AND METHOD FOR OPTIMIZED TRAFFIC FLOW THROUGH INTERSECTIONS WITH CONDITIONAL CONVOYING BASED ON PATH NETWORK ANALYSIS

(71) Applicant: Seegrid Corporation, Pittsburgh, PA (US)

(72) Inventors: Jeff Hoskinson, Pittsburgh, PA (US); Nicholas Alan Melchior, Pittsburgh, PA (US); Benjamin George Schmidt, Wexford, PA (US)

(21) Appl. No.: 18/502,221

(22) Filed: Nov. 6, 2023

Related U.S. Application Data
(60) Provisional application No. 63/423,683, filed on Nov. 8, 2022.

(51) Int. Cl. G05D 1/02; G05D 1/00

(52) U.S. Cl. CPC G05D 1/0214; G05D 1/0088; G05D 1/0219; G05D 2201/0207

(57) ABSTRACT

A system and method are provided that enable improved or optimized traffic flow through intersections with conditional convoying based on path network analysis. In some embodiments, the system and/or method comprise: an autonomous first agent traveling along a first path through an intersection; an autonomous second agent traveling along a second path; and at least one processor configured to selectively grant or deny the second agent access to the intersection based, at least in part, on the first agent's travel relative to the intersection.

### CROSS REFERENCE TO RELATED APPLICATIONS

The present application claims priority to U.S. Provisional Patent Appl. No. 63/423,683, filed on Nov. 8, 2022, which is incorporated herein by reference in its entirety.

The present application may be related to International Application No. PCT/US23/016556 filed on Mar. 28, 2023, entitled A Hybrid, Context-Aware Localization System For Ground Vehicles; International Application No. PCT/US23/016565 filed on Mar. 28, 2023, entitled Safety Field Switching Based On End Effector Conditions In Vehicles; International Application No. PCT/US23/016608 filed on Mar. 28, 2023, entitled Dense Data Registration From An Actuatable Vehicle Mounted Sensor; International Application No. PCT/U.S. Pat. No. 23,016,589, filed on Mar. 28, 2023, entitled Extrinsic Calibration Of A Vehicle-Mounted Sensor Using Natural Vehicle Features; International Application No. PCT/US23/016615, filed on Mar. 28, 2023, entitled Continuous And Discrete Estimation Of Payload Engagement/Disengagement Sensing; International Application No. PCT/US23/016617, filed on Mar. 28, 2023, entitled Passively Actuated Sensor System; International Application No. PCT/US23/016643, filed on Mar. 28, 2023, entitled Automated Identification Of Potential Obstructions In A Targeted Drop Zone; International Application No. PCT/US23/016641, filed on Mar. 28, 2023, entitled Localization of Horizontal Infrastructure Using Point Clouds; International Application No. PCT/US23/016591, filed on Mar. 28, 2023, entitled Robotic Vehicle Navigation With Dynamic Path Adjusting; International Application No. PCT/US23/016612, filed on Mar. 28, 2023, entitled Segmentation of Detected Objects Into Obstructions and Allowed Objects; International Application No. PCT/US23/016554, filed on Mar. 28, 2023, entitled Validating the Pose of a Robotic Vehicle That Allows It To Interact With An Object On Fixed Infrastructure; and International Application No. PCT/US23/016551, filed on Mar. 28, 2023, entitled A System for AMRs That Leverages Priors When Localizing and Manipulating Industrial Infrastructure; International Application No.: PCT/US23/024114, filed on Jun. 1, 2023, entitled System and Method for Generating Complex Runtime Path Networks from Incomplete Demonstration of Trained Activities; International Application No.: PCT/US23/023699, filed on May 26, 2023, entitled System and Method for Performing Interactions with Physical Objects Based on Fusion of Multiple Sensors; International Application No.: PCT/US23/024411, filed on Jun. 5, 2023, entitled Lane Grid Setup for Autonomous Mobile Robots (AMRs); to U.S. Provisional Patent Appl. No. 63/410,355 filed on Sep. 27, 2022, entitled Dynamic, Deadlock-Free Hierarchical Spatial Mutexes Based on a Graph Network; U.S. Provisional Appl. 63/423,679, filed Nov. 8, 2022, entitled System and Method for Definition of a Zone of Dynamic Behavior with a Continuum of Possible Actions and Structural Locations within Same; U.S. Provisional Appl. 63/423,538, filed Nov. 8, 2022, entitled Method for Calibrating Planar Light-Curtain; U.S. Provisional Appl. 63/430,184 filed on Dec. 5, 2022, entitled Just in Time Destination Definition and Route Planning; U.S. Provisional Appl. 63/430,190 filed on Dec. 5, 2022, entitled Configuring a System that Handles Uncertainty with Human and Logic Collaboration in a Material Flow Automation Solution; U.S. Provisional Appl. 63/430,182 filed on Dec. 5, 2022, entitled Composable Patterns of Material Flow Logic for the Automation of Movement; U.S. Provisional Appl. 63/430,174 filed on Dec. 5, 2022, entitled Process Centric User Configurable Step Framework for Composing Material Flow Automation; U.S. Provisional Appl. 63/430,195 filed on Dec. 5, 2022, entitled Generation of “Plain Language” Descriptions Summary of Automation Logic; U.S. Provisional Appl. 63/430,171 filed on Dec. 5, 2022, entitled Hybrid Autonomous System Enabling and Tracking Human Integration into Automated Material Flow; U.S. Provisional Appl. 63/430,180 filed on Dec. 5, 2022, entitled A System for Process Flow Templating and Duplication of Tasks Within Material Flow Automation; U.S. Provisional Appl. 63/430,200 filed on Dec. 5, 2022, entitled A Method for Abstracting Integrations Between Industrial Controls and Autonomous Mobile Robots (AMRs); and U.S. Provisional Appl. 63/430,170 filed on Dec. 5, 2022, entitled Visualization of Physical Space Robot Queuing Areas as Non Work Locations for Robotic Operations, each of which is incorporated herein by reference in its entirety.

The present application may be related to U.S. patent application Ser. No. 11/350,195, filed on Feb. 8, 2006, U.S. Pat. No. 7,466,766, Issued on Nov. 4, 2008, entitled Multidimensional Evidence Grids and System and Methods for Applying Same; U.S. patent application Ser. No. 12/263,983 filed on Nov. 3, 2008, U.S. Pat. No. 8,427,472, Issued on Apr. 23, 2013, entitled Multidimensional Evidence Grids and System and Methods for Applying Same; U.S. patent application Ser. No. 11/760,859, filed on Jun. 11, 2007, U.S. Pat. No. 7,880,637, Issued on Feb. 1, 2011, entitled Low-Profile Signal Device and Method For Providing Color-Coded Signals; U.S. patent application Ser. No. 12/361,300 filed on Jan. 28, 2009, U.S. Pat. No. 8,892,256, Issued on Nov. 18, 2014, entitled Methods For Real-Time and Near-Real Time Interactions With Robots That Service A Facility; U.S. patent application Ser. No. 12/361,441, filed on Jan. 28, 2009, U.S. Pat. No. 8,838,268, Issued on Sep. 16, 2014, entitled Service Robot And Method Of Operating Same; U.S. patent application Ser. No. 14/487,860, filed on Sep. 16, 2014, U.S. Pat. No. 9,603,499, Issued on Mar. 28, 2017, entitled Service Robot And Method Of Operating Same; U.S. patent application Ser. No. 12/361,379, filed on Jan. 28, 2009, U.S. Pat. No. 8,433,442, Issued on Apr. 30, 2013, entitled Methods For Repurposing Temporal-Spatial Information Collected By Service Robots; U.S. patent application Ser. No. 12/371,281, filed on Feb. 13, 2009, U.S. Pat. No. 8,755,936, Issued on Jun. 17, 2014, entitled Distributed Multi-Robot System; U.S. patent application Ser. No. 12/542,279, filed on Aug. 17, 2009, U.S. Pat. No. 8,169,596, Issued on May 1, 2012, entitled System And Method Using A Multi-Plane Curtain; U.S. patent application Ser. No. 13/460,096, filed on Apr. 30, 2012, U.S. Pat. No. 9,310,608, Issued on Apr. 12, 2016, entitled System And Method Using A Multi-Plane Curtain; U.S. patent application Ser. No. 15/096,748, filed on Apr. 12, 2016, U.S. Pat. No. 9,910,137, Issued on Mar. 6, 2018, entitled System and Method Using A Multi-Plane Curtain; U.S. patent application Ser. No. 13/530,876, filed on Jun. 22, 2012, U.S. Pat. No. 8,892,241, Issued on Nov. 18, 2014, entitled Robot-Enabled Case Picking; U.S. patent application Ser. No. 14/543,241, filed on Nov. 17, 2014, U.S. Pat. No. 9,592,961, Issued on Mar. 14, 2017, entitled Robot-Enabled Case Picking; U.S. patent application Ser. No. 13/168,639, filed on Jun. 24, 2011, U.S. Pat. No. 8,864,164, Issued on Oct. 21, 2014, entitled Tugger Attachment; U.S. Design patent application 29/398,127, filed on Jul. 26, 2011, U.S. Pat. No. D680,142, Issued on Apr. 16, 2013, entitled Multi-Camera Head; U.S. Design patent application 29/471,328, filed on Oct. 30, 2013, U.S. Pat. No. D730,847, Issued on Jun. 2, 2015, entitled Vehicle Interface Module; U.S. patent application Ser. No. 14/196,147, filed on Mar. 4, 2014, U.S. Pat. No. 9,965,856, Issued on May 8, 2018, entitled Ranging Cameras Using A Common Substrate; U.S. patent application Ser. No. 16/103,389, filed on Aug. 14, 2018, U.S. Pat. No. 11,292,498, Issued on Apr. 5, 2022, entitled Laterally Operating Payload Handling Device; U.S. patent application Ser. No. 17/712,660, filed on Apr. 4, 2022, US Publication Number 2022/0297734, Published on Sep. 22, 2022, entitled Laterally Operating Payload Handling Device; U.S. patent application Ser. No. 16/892,549, filed on Jun. 4, 2020, U.S. Pat. No. 11,693,403, Issued on Jul. 4, 2023, entitled Dynamic Allocation And Coordination of Auto-Navigating Vehicles and Selectors; U.S. patent application Ser. No. 18/199,052, filed on May 18, 2023, Publication Number ______, Published on ______, entitled Dynamic Allocation And Coordination of Auto Navigating Vehicles and Selectors; U.S. patent application Ser. No. 17/163,973, filed on Feb. 1, 2021, US Publication Number 2021/0237596, Published on Aug. 5, 2021, entitled Vehicle Auto-Charging System and Method; U.S. patent application Ser. No. 17/197,516, filed on Mar. 10, 2021, US Publication Number 2021/0284198, Published on Sep. 16, 2021, entitled Self-Driving Vehicle Path Adaptation System and Method; U.S. patent application Ser. No. 17/490,345, filed on Sep. 30, 2021, US Publication Number 2022/0100195, Published on Mar. 31, 2022, entitled Vehicle Object-Engagement Scanning System And Method; U.S. patent application Ser. No. 17/478,338, filed on Sep. 17, 2021, US Publication Number 2022/0088980, Published on Mar. 24, 2022, entitled Mechanically-Adaptable Hitch Guide; U.S. patent application Ser. No. 29/832,212, filed on Mar. 25, 2022, entitled Mobile Robot, each of which is incorporated herein by reference in its entirety.

### FIELD OF INTEREST

The present inventive concepts relate to the field of robotics and autonomous mobile robots (AMRs). In particular, the inventive concepts may be related to systems and methods in the field of coordinating mobile robots with respect to shared spaces, which can be implemented by or in an AMR.

### BACKGROUND

AMRs are becoming increasingly prevalent, particularly in commercial settings. The term AMR, as used herein, encompasses self-driving vehicles, autonomous vehicles, auto-navigating vehicles, automated guided vehicles (AGV), and vision guided vehicles (VGVs).

One environment in which AMRs have become particularly useful is the warehouse environment, i.e., an environment in which goods are received, stored, and then transported. In such an environment, the goods tend to be transient. Received goods are moved to storage locations in the environment, where they are temporarily stored awaiting subsequent disposition. The storage is generally intended to be temporary, as such goods ultimately may be intended for a retailer, consumer or customer, distributor, transporter or other subsequent receiver. A warehouse can be a standalone facility or can be part of a multi-use facility. Thousands of types of items may be stored in a typical warehouse. The items can be small or large, individual or bulk. It is common to load items on a pallet or in carts for transportation, and the warehouse may use pallets and tuggers as a manner of internally transporting and storing such items.

A well-run warehouse is well-organized and maintains an accurate inventory of goods. Goods can come and go frequently, throughout the day, in a warehouse. In fact, some large and very busy warehouses work three shifts, continually moving goods throughout the warehouse as they are received or needed to fulfill orders. Shipping and receiving areas, which may be collocated, are the location(s) within the warehouse where large trucks pick-up and drop-off goods. The warehouse can also include a staging area—an intermediate area between shipping and receiving and storage aisles within the warehouse where the goods are stored. The staging area may be used for confirming that all items on the shipping manifest were received in acceptable condition. The staging area can also be used to build orders and pallets to fulfill orders that are to be shipped out.

Goods in a warehouse tend to be moved in one of two ways, either by pallet or by cart (or trailer). A pallet requires a pallet transport for movement, such as a pallet jack, pallet truck, forklift, or stacker. A stacker is a piece of equipment that is similar to a forklift, but can raise the pallet to significantly greater heights, e.g., for loading a pallet on a warehouse shelf. A cart requires a tugger (or “tow tractor”), which enables a user to pull the cart from place to place.

A pallet transport can be manual or motorized. A traditional pallet jack is a manually operated piece of equipment, as is a traditional stacker. When a pallet transport is motorized, it can take the form of a powered pallet jack, pallet truck, or forklift (or lift truck). A motorized stacker is referred to as a power stacker. A motorized pallet jack is referred to as a powered pallet jack, which an operator cannot ride, but walks beside. A pallet truck is similar to a powered pallet jack, but it includes a place for an operator to stand.

As with motorized pallet transports, a tugger can be in the form of a drivable vehicle or in the form of a powered vehicle along the side of which the operator walks. In either form, a tugger includes a hitch that engages with a companion part on the cart, such as a sturdy and rigid ring or loop.

Various types of vehicles exist that can navigate without direct reliance on a human driver, such as autonomous mobile robots (AMRs), automated guided vehicle (AGV), vision guided vehicles (VGV), and autonomous guided carts (AGCs), as examples. For clarity and brevity of explanation, such vehicles will be collectively referred to herein as AMRs. AMR forms of pallet trucks and powered tuggers exist. They are most often used in industrial applications to move materials and/or goods around a manufacturing facility or a warehouse, such as in the case of AMR forklifts and AMR tuggers.

Such AMRs tend to travel according to a pre-planned path, for which the vehicle may have been trained. Such training can include one or more training runs over the path, which is recorded for future use by the AMR. The vehicle path takes into account objects, such as walls, installed equipment, and other permanent objects, such that the path avoids such objects. Sensors onboard the AMR can detect new or temporary objects encountered during navigation of the path at run time. Approaches for auto-navigating a vehicle may entail stopping the vehicle when any object is detected by the sensors.

With increasing numbers and types of environments autonomous vehicles may travel through areas and/or along pathways that are shared with other vehicles and/or pedestrians. Such other vehicles can include other autonomous vehicles, semi-autonomous vehicles, and/or manually operated vehicles. The autonomous vehicles can take a variety of forms and can be referred to using various terms, such as mobile robots, robotic vehicles, automated guided vehicles, and/or autonomous mobile robots (AMRs). In some cases, these vehicles can be configured for operation in an autonomous mode where they self-navigate or in a manual mode where a human directs the vehicle's navigation.

Areas of potential conflict or contention, whether spaces, aisles, roadways, and/or pathways, can be referred to as “intersections.” Various environments include intersections through which multiple vehicles may have to negotiate safe travel. In such circumstances, a plurality of AMRs (including carts, trailers, forklifts, etc.) could have overlapping or nearly-overlapping paths through an intersection at or nearly at the same time. It is a challenge to enable multiple AMRs with overlapping paths to move through the same intersection without collision or deadlock.

To accomplish navigation through an intersection, an AMR must prioritize safety. This can be accomplished by configuring the AMRs with a rule set that is executed to enable a single AMR to pass through the intersection at a time. However, reserving an intersection for a single AMR, when not necessary, can significantly reduce the throughput of the system.

### SUMMARY

In accordance with various aspects of the inventive concepts, provided is a system, comprising: a first agent traveling along a first path through an intersection; a second agent traveling along a second path that overlaps the first path in the intersection; and at least one processor configured to selectively grant or deny the second agent access to the intersection based, at least in part, on the first agent's travel relative to the intersection.

In various embodiments, at least one of the first agent or the second agent is an autonomous mobile robot (AMR).

In various embodiments, the at least one processor is in communication with at least one computer storage device comprising an intersection management program code executable by the at least one processor.

In various embodiments, the at least one processor includes a processor configured to selectively grant and deny access to a plurality of AMRs requesting access to the intersection.

In various embodiments, the at least one processor includes a processor configured to selectively grant the second agent access to the intersection if the first agent does not and/or will not travel in a reverse direction relative to the intersection.

In various embodiments, the at least one processor includes a processor configured to selectively grant the second agent access to the intersection if the first agent does not and/or will not reverse direction relative to the intersection.

In various embodiments, the at least one processor includes a processor configured to selectively grant the second agent access to the intersection if the first agent does not and/or will not move towards the second agent in the intersection.

In various embodiments, the at least one processor includes a processor configured to selectively grant the second agent access to the intersection if the first agent moving and/or will move at least partially in the same direction as the second agent in the intersection.

In various embodiments, the at least one processor includes a processor at the first agent configured to communicate with a server configured to grant and deny access to the intersection.

In various embodiments, the intersection comprises a plurality of paths and/or path segments.

In various embodiments, the at least one processor includes a processor configured to selectively grant the second agent access to the intersection if the first path is the same or substantially the same as the second path and the first agent and the second agent are moving and/or will move in the same direction relative to the intersection.

In various embodiments, the at least one processor includes a processor configured to selectively grant the second agent access to the intersection if the first path is the same o substantially the same as the second path and the first agent is not moving and/or will not move in a reverse direction relative to a direction the first agent moved to enter the intersection.

In accordance with various aspects of the inventive concepts, provided is a method, comprising: providing an autonomous first agent; providing an autonomous second agent; providing at least one processor in communication with the first and second agents; the first agent traveling along a first path through an intersection; the second agent traveling along a second path; and the at least one processor selectively granting or denying the second agent access to the intersection based, at least in part, on the first agent's travel relative to the intersection.

In various embodiments, at least one of the first agent or the second agent is an autonomous mobile robot (AMR).

In various embodiments, the method includes the at least one processor executing an intersection management program code stored at or in least one computer storage device.

In various embodiments, the method includes the at least one processor selectively granting and/or denying access to a plurality of AMRs requesting access to the intersection.

In various embodiments, the method includes the at least one processor selectively granting the second agent access to the intersection if the first agent is not and/or will not be traveling in a reverse direction relative to the intersection.

In various embodiments, the method includes the at least one processor selectively granting the second agent access to the intersection if the first agent does not and/or will not reverse direction relative to the intersection.

In various embodiments, the method includes the at least one processor selectively granting the second agent access to the intersection if the first agent is not and/or will not be moving towards the second agent in the intersection.

In various embodiments, the method includes the at least one processor selectively granting the second agent access to the intersection if the first agent does not and/or will not move at least partially in the same direction as the second agent in the intersection.

In various embodiments, the at least one processor includes a server and the method includes the second agent requesting intersection access from the server and the server granting and/or denying the second agent access to the intersection based, at least in part, on the path of the first agent through the intersection.

In various embodiments, the intersection comprises a plurality of paths and/or path segments.

In various embodiments, the method includes the at least one processor selectively granting the second agent access to the intersection if the first path is the same or substantially the same as the second path and the first agent and the second agent are moving and/or will move in the same direction relative to the intersection.

In various embodiments, the method includes the at least one processor selectively granting the second agent access to the intersection if the first path is the same or substantially as the second path and the first agent is not moving and/or will not move in a reverse direction relative to a direction the first agent moved to enter the intersection.

### BRIEF DESCRIPTION OF THE DRAWINGS

The present inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1 is a perspective view of an embodiment of an AMR forklift that may employ systems and methods in accordance with principles of inventive concepts;

FIG. 2 is a block diagram of an example embodiment of a system in accordance with principles of inventive concepts;

FIG. 3 is a flow chart of an example embodiment training process that includes the introduction of intersection behaviors in accordance with principles of inventive concepts;

FIG. 4 is a flow chart of an example embodiment of an AMR executing a path including intersection behaviors in accordance with principles of inventive concepts;

FIGS. 5A through 5D illustrate intersections such as may be encountered by AMRs in accordance with principles of inventive concepts; and

FIGS. 6-9 illustrated example embodiments of AMR intersection behaviors in accordance with principles of inventive concepts.

### DETAILED DESCRIPTION OF PREFERRED EMBODIMENTS

Various aspects of the inventive concepts will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

To the extent that functional features, operations, and/or steps are described herein, or otherwise understood to be included within various embodiments of the inventive concept, such functional features, operations, and/or steps can be embodied in functional blocks, units, modules, operations and/or methods. And to the extent that such functional blocks, units, modules, operations and/or methods include computer program code, such computer program code can be stored in a computer readable medium, e.g., such as non-transitory memory and media, that is executable by at least one computer processor.

In accordance with aspect of the inventive concepts, a system and method are provided that enable optimized traffic flow through intersections with conditional convoying based on path network analysis. In some embodiments, a system and/or method comprises one or more AMRs; a graph network describing flow through an environment, including directionality of travel; and a server configured to manage the AMRs. Managing AMRs can include selectively sending signals to AMRs seeking travel through an intersection, such signals can include wait (access not yet granted) and/or access granted signals. In example embodiments an intersection may refer to any region where an AMR is required to receive permission to enter and which permission the AMR relinquishes upon ext. These regions are generally defined around areas where the paths of an AMR may overlap with that of another vehicle, such as AMR or AGV, for example.

In example embodiments information for making safe, optimized traffic flow decisions may be encoded in a path network during the training/building phase and an AMR's path creation. This reduces the processing burden for a central server/supervisory processor and follow, or run, time by eliminating the need for the supervisory processor to have spatial information like a global metric map and how the AMRs are moving through it.

In example embodiments AMRs request access as they approach the entrance to an intersection along their path, which may be a during a “follow” of a trained path, for example. A supervisory processor grants, denies, or allows limited access, depending upon factors that ensure safe flow of AMR through the intersection.

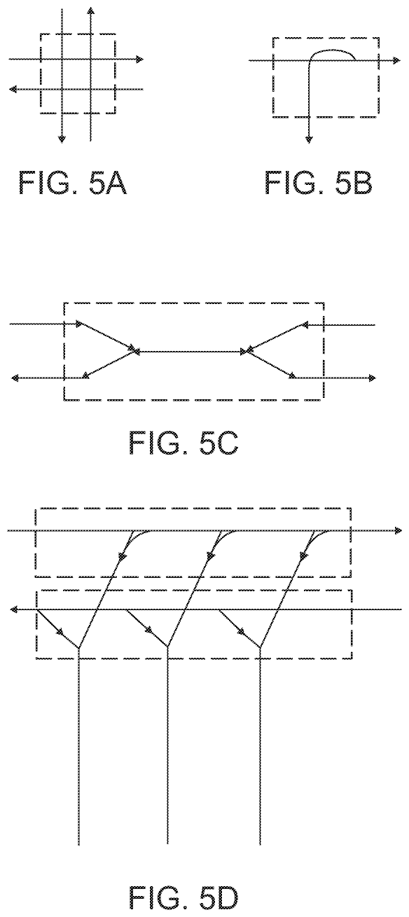

In example embodiments a general process of travel through an intersection may entail an AMR requesting from a supervisory processor access to an intersection as it approaches the intersection. The approach distance, that is the distance from the intersection entrance, at which the AMR requests access may be configurable in example embodiments. AMRs may delay access requests in order to maximize access to an intersection, and throughput, for other AMRs. For example, an AMR may delay requesting access until after it has made stops included in its follow path. In example embodiments the supervisory processor grants access if there is no other traffic in the intersection. In some cases, if there is other traffic through the intersection but the path of the other traffic does not conflict with the path of the requesting AMR, the supervisory processor may grant access to the requesting AMR. If, for example, the intersection is a four-way intersection (see FIG. 5A, for example) with separate north and south aisles and separate east and west aisles, multiple AMRs may be allowed access to east and west or north and south aisles simultaneously (but not east or west and north or south).

In example embodiments a supervisory processor may grant access to a requesting AMR if no other AMR sharing a path or a portion of a path through the intersection possesses access to the intersection.

In example embodiments a supervisory processor may grant access to a requesting AMR if another AMR sharing a path or a portion of a path already has non-exclusive access to the intersection.

In example embodiments a supervisory processor may grant access to a requesting AMR if another AMR sharing a path or a portion of a path already has non-exclusive access to the intersection.

In example embodiments a supervisory processor may not grant access to a requesting AMR if another AMR sharing a path or a portion of a path through the intersection possesses exclusive or qualified exclusive access to the intersection.

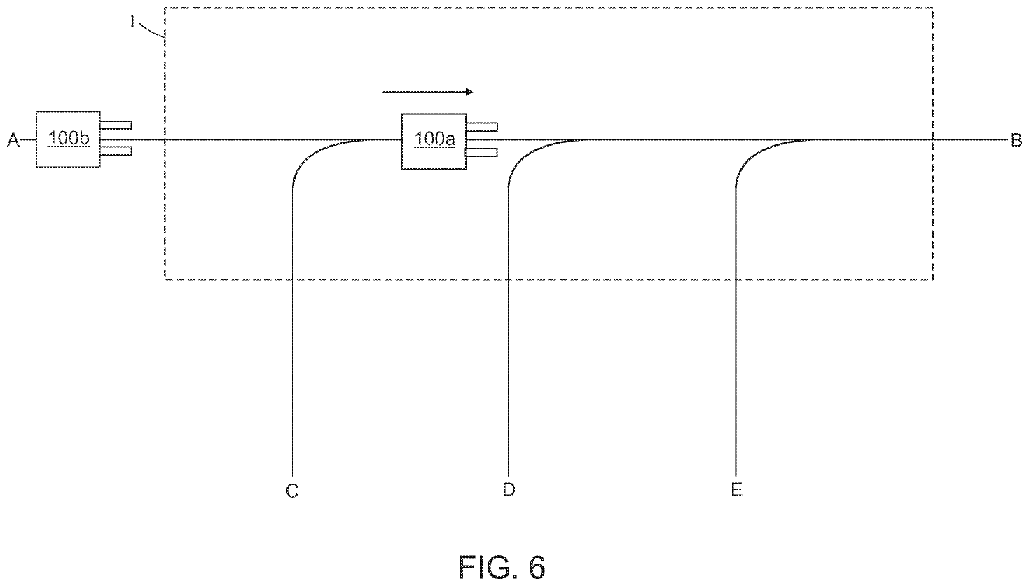

In example embodiments a supervisory processor may grant access to a requesting AMR if another AMR sharing a path or a portion of a path through the intersection possesses qualified exclusive access to the intersection and the qualified exclusive access indicates that the path of the possessing AMR will not obstruct the path of the requesting AMR. The qualified exclusive access may correspond to the AMR's obstructing action distance from the entrance of the intersection and may be given in terms of the number of exits from the entrance, for example. In an example in which three lateral exits are available, such as in the example of FIG. 6, where lateral exits C, D, and E are available. In such cases qualified exclusive access to be granted to AMRs according to the turn/exit their path leads them through, with qualified exclusive access level 3 granted to an AMR that is going to turn out at exit E, qualified exclusive access level 2 granted to an AMR that is going to turn out at exit D, and qualified exclusive access level 1 granted to an AMR that is going to turn out at exit C. Only requesting AMRs with a lower exit level than that of an AMR with an existing qualified exclusive access level may obtain their own qualified exclusive access. As with all accesses, an AMR releases its access when it exits the intersection.

In accordance with aspects of the inventive concepts, provided is a method for managing and/or optimizing a flow of AMRs through an intersection, the method comprising: using the presence of reverse motion of an AMR to reserve the intersection for exclusive access by the AMR; using a route through the intersection to allow multiple, non-reversing, AMRs to proceed through together; and using an off-board computer (such as a server) to enforce these access restrictions, such as through the granting of access to the AMR or through communicating a signal to an AMR causing the AMR to wait before entering the intersection until access is granted.

It would be advantageous to allow multiple AMRs with overlapping paths to move together through an intersection without collisions or deadlocks. As used herein, paths are overlapping if two or more AMRs would travel a portion of the same path through the intersection at near the same time.

Some existing systems implement rules that attempt to avoid deadlocks and collisions, but, among various shortcomings, such systems do not allow more than one AMR to move through an intersection together, at or near the same time. In some embodiments the systems and methods described herein analyze the circumstances under which multiple AMRs can safely share or navigate an intersection, taking into account the paths of the AMRs through the intersection and whether reverse motion in one or more of the paths is involved. In some embodiments, the systems and methods described herein are configured to improve or maximize throughput, while avoiding collisions, by analyzing the paths a plurality of AMRs are to take through an intersection.

In some embodiments, the systems and methods herein incorporate the following steps:
1. Electronically mark or otherwise indicate any intersection that an AMR moves through in reverse as allowing only a single AMR to pass through.
2. In intersections not so marked or indicated, allowing AMRs following substantially the same path through the intersection to move through it at the same time.

In various embodiments, travelling the same path includes traveling in the same direction through the intersection.

In some embodiments, in order to increase throughput of AMRs, a system in accordance with principles of inventive concepts may allow multiple AMRs to travel through the intersection at the same time if the following conditions are met:
1. All AMRs are traveling the same path through the intersection, and
2. There is no reverse motion inside the intersection.

In various embodiments, if either of these conditions are not met, only one AMR will be permitted in the intersection at a time, in order to prevent obstruction deadlocks inside the intersection.

In some embodiments, the systems and methods herein may incorporate the following steps:
1. A processor, in communication with the AMRs, mediates access to areas of potential conflict (“intersections”). The processor may be a supervisory system such as Supervisor™, described in greater detail herein.
2. While training the paths the AMRs will follow, electronically mark or indicate intersections, where multiple paths may cross.
3. Before an AMR attempts to enter an intersection, it will request permission from the processor.
a. If the AMR will be making any reverse movements in the intersection, it will request exclusive access to the intersection, to prevent collision with another AMR.
4. In some embodiments, a supervisory processor may analyze the circumstances to determine if the AMR should be allowed access to the intersection and communicate with the AMR accordingly, as follows:
a. If no other AMR is in the intersection, the AMR will be granted access to the intersection.
b. If a prior AMR, was granted exclusive access to the intersection, the requesting AMR will be required to wait until the prior AMR has released its exclusive access to the intersection.
c. If a prior AMR was granted non-exclusive access to the intersection, the supervisory processor may analyze the AMRs' paths through the intersection. If two AMRs will be following the same path, the processor will allow the new, requesting, AMR to enter the intersection. If the new, requesting, AMR is following a different path, the processor will deny it access, to prevent collision and grant it access when the prior AMR has relinquished its exclusive access to the intersection.

In some embodiments, the systems and methods described herein take into account movement through areas on a case-by-case basis, rather than setting it when first training. In alternative embodiments, the systems and methods described herein are set during training, e.g., during AMR runs used to “train” the AMR's routes through the environment. That is, in example embodiments, when an AMR is trained its path entrances (locations where the AMR awaits access to an intersection) and path exits (locations where the AMR relinquishes access) are included in the training process. In some embodiments entrances and exits may not be fixed during training. For example, entrances and exits may not be fixed when entrances may be dynamically expanded to avoid deadlock when multiple AMRs are traversing intersections that fully or partially overlap. Such cases are addressed in greater detail in, “Dynamic, Deadlock-Free Hierarchical Spatial Mutexes Based on a Graph Network,” PCT/US23/033818, which is hereby incorporated by reference in its entirety.

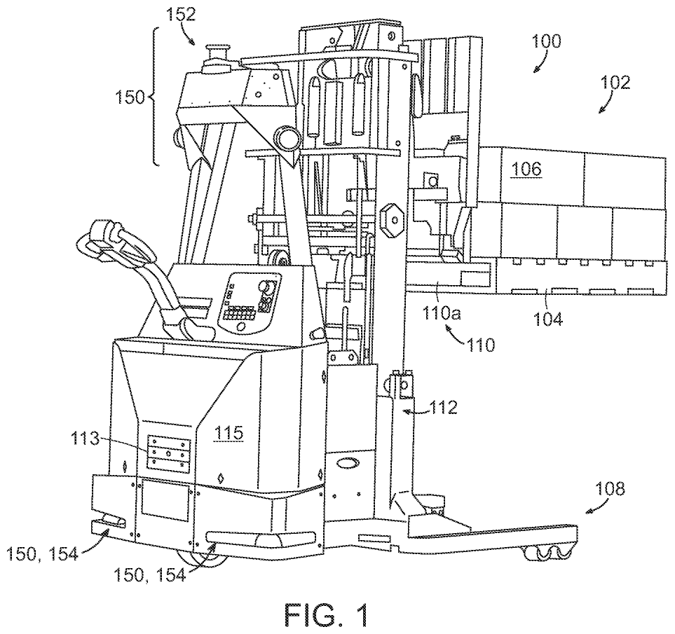

Although inventive concepts may be employed with any of a variety of autonomous mobile robots (AMRs) for brevity and clarity of description example embodiments will be primarily directed herein to AMR fork trucks, an example embodiment of which is illustrated in FIG. 1.

FIG. 1 is a perspective view of an embodiment of an AMR forklift 100 in accordance with aspects of the inventive concepts that includes features described herein. In some embodiments, such as the one shown in FIG. 1, the AMR includes a load engagement portion 110, such as a pair of forks 110a, 110b.

The forks 110 extend from the AMR in a first direction. The AMR may be configured to travel primarily in the first direction and, secondarily, in a second direction. The second direction can be considered opposite to the first direction, understanding that the AMRs have turning capability in both directions. When an AMR travels into an intersection in one direction, i.e., the first or second direction, changing the travel direction to the other of the first and second directions will be referred to as “reverse” motion herein. In some embodiments, a direction the AMR initially travels into the intersection with will be considered to be a forward direction and subsequently traveling within or through the same intersection in the opposite direction will be considered reversing direction or travelling in the reverse direction.

Aspects of inventive concepts disclosed herein relate to safely increasing the throughput of AMRs through areas of possible conflict. In various embodiments, a user interface can be provided to input intersection information, for example, during training of an AMR. The user interface (UI) can be provided on the AMR or on a computer that communicates with the AMR, such as a laptop, tablet, phablet, desktop, mobile phone, or other such computer device having a user interface. A “wizard” may be generated at or within the UI to assist a user in inputting information necessary for travel through one or more intersections, e.g., the wizard user interface can present computer displays that guide a user through entering intersection information.

In some embodiments, aspects of the inventive concepts are configured to work with Seegrid AMRs, such as Seegrid's Palion™ line of AMRs. In some embodiments, aspects of the inventive concepts disclosed herein are configured to work with a warehouse management system (WMS), such as Seegrid Supervisor™, as described in greater detail below. In other embodiments, systems and methods in accordance with the inventive concepts can be implemented with other forms of autonomously navigated vehicles and/or mobile robots and warehouse management systems.

In example embodiments a robotic vehicle may include a user interface, such as a graphical user interface, which may also include audio or haptic input/output capability, that may allow feedback to be given to a human-trainer while registering a piece of industrial infrastructure (such as a pallet) to a particular location in the facility using a Graphical Operator Interface integral to the AMR. The interface may include a visual representation and associated text. In alternative embodiments, the feedback device may include a visual representation without text.

In some embodiments, the systems and methods described herein rely on the Grid Engine for spatial registration of the descriptors to the facility map. Some embodiments of the system may exploit features of “A Hybrid, Context-Aware Localization System for Ground Vehicles” which builds on top of the Grid Engine, Application No. PCT/US2023/016556, which is hereby incorporated by reference in its entirety. Some embodiments may leverage a Grid Engine localization system, such as that provided by Seegrid Corporation of Pittsburgh, PA described in U.S. Pat. Nos. 7,446,766 and 8,427,472, which is incorporated by reference in its entirety.

In some embodiments, an AMR may interface with industrial infrastructure to pick and drop pallets, for example. In order for an AMR to accomplish this, its perception and manipulation systems in accordance with principles of inventive concepts may maintain a model for what a pallet is, as well as models for all the types of infrastructure for which it will place the pallet (e.g., tables, carts, racks, conveyors, etc.). These models are software components that are parameterized in a way to influence the algorithmic logic of the computation.

In example embodiments a route network may be constructed by an operator through training-by-demonstration, wherein an operator leads the AMR through a training route and inputs behaviors (for example, picks or places) along the route. A build procedure employs information gathered during training (for example, odometry, grid information including localization information, and operator input regarding behaviors) into a route network. The route network may then be employed by an AMR to autonomously follow during normal operation. The route network may be modeled, or viewed, as a graph of nodes and edges, with stations as nodes and trained segments as edges. Behaviors may be trained within segments. Behaviors may include “point behaviors” such as picks and drops or “zone behaviors” such as intersections. In example embodiments an AMR's repetition during normal operations of a trained route may be referred to as a “follow.” Anything, other than the follow itself, the AMR does during the follow may be viewed as a behavior. Zones such as intersections may include behaviors that are performed before, during, and/or after the zone. For intersections, the AMR requests access to the intersection from a supervisory system, also referred to herein as a supervisor or supervisory processor, (for example, Supervisor™ described elsewhere herein) prior to reaching the area covered by the intersection zone. When the AMR exits the zone, it releases that access to the supervisory system.

Referring to FIG. 1, shown is an example of a robotic vehicle 100 in the form of an AMR that can be configured with the sensing, processing, and memory devices and subsystems necessary and/or useful for lane building or depletion in accordance with aspects of the inventive concepts. The robotic vehicle 100 takes the form of an AMR pallet lift, but the inventive concepts could be embodied in any of a variety of other types of robotic vehicles and AMRs, including, but not limited to, pallet trucks, tuggers, and the like.

In this embodiment, the robotic vehicle 100 includes a payload area 102 configured to transport a pallet 104 loaded with goods 106. To engage and carry the pallet 104, the robotic vehicle may include a pair of forks 110, including a first and second fork 10a, b. Outriggers 108 extend from the robotic vehicle in the direction of the forks to stabilize the vehicle, particularly when carrying the palletized load 106. The robotic vehicle 100 can comprise a battery area 112 for holding one or more batteries. In various embodiments, the one or more batteries can be configured for charging via a charging interface 113. The robotic vehicle 100 can also include a main housing 115 within which various control elements and subsystems can be disposed, including those that enable the robotic vehicle to navigate from place to place.

The robotic vehicle 100 may include a plurality of sensors 150 that provide various forms of sensor data that enable the robotic vehicle to safely navigate throughout an environment, engage with objects to be transported, and avoid obstructions. In various embodiments, the sensor data from one or more of the sensors 150 can be used for path adaptation, including avoidance of detected objects, obstructions, hazards, humans, other robotic vehicles, and/or congestion during navigation. The sensors 150 can include one or more cameras, stereo cameras 152, radars, and/or laser imaging, detection, and ranging (LiDAR) scanners 154. One or more of the sensors 150 can form part of a 2D or 3D high-resolution imaging system.

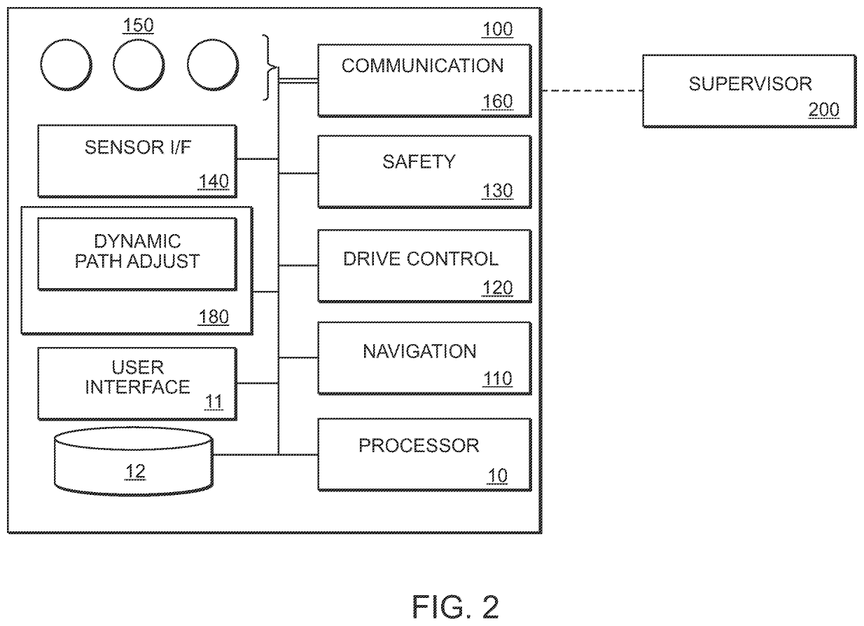

FIG. 2 is a block diagram of components of an embodiment of the robotic vehicle 100 of FIG. 1, incorporating intersection access technology in accordance with principles of inventive concepts. The embodiment of FIG. 2 is an example; other embodiments of the robotic vehicle 100 can include other components and/or terminology. In the example embodiment shown in FIGS. 1 and 2, the robotic vehicle 100 is a warehouse robotic vehicle, which can interface and exchange information with one or more external systems, including a supervisor system, fleet management system, and/or warehouse management system (collectively “Supervisor 200”). In various embodiments, the supervisor 200 could be configured to perform, for example, fleet management and monitoring for a plurality of vehicles (e.g., AMRs) and, optionally, other assets within the environment. The supervisor 200 can be local or remote to the environment, or some combination thereof.

In various embodiments, the supervisor 200 can be configured to provide instructions and data to the robotic vehicle 100, and to monitor the navigation and activity of the robotic vehicle and, optionally, other robotic vehicles. The robotic vehicle can include a communication module 160 configured to enable communications with the supervisor 200 and/or any other external systems. The communication module 160 can include hardware, software, firmware, receivers, and transmitters that enable communication with the supervisor 200 and any other external systems over any now known or hereafter developed communication technology, such as various types of wireless technology including, but not limited to, Wi-Fi, Bluetooth, cellular, global positioning system (GPS), radio frequency (RF), and so on.

As an example, the supervisor 200 could wirelessly communicate a path for the robotic vehicle 100 to navigate for the vehicle to perform a task or series of tasks. The path can be relative to a map of the environment stored in memory and, optionally, updated from time-to-time, e.g., in real-time, from vehicle sensor data collected in real-time as the robotic vehicle 100 navigates and/or performs its tasks. The sensor data can include sensor data from sensors 150. As an example, in a warehouse setting the path could include a plurality of stops along a route for the picking and loading and/or the unloading of goods. The path can include a plurality of path segments. The navigation from one stop to another can comprise one or more path segments. The supervisor 200 can also monitor the robotic vehicle 100, such as to determine robotic vehicle's location within an environment, battery status and/or fuel level, and/or other operating, vehicle, performance, and/or load parameters.

In example embodiments, a path may be developed by “training” the robotic vehicle 100. That is, an operator may guide the robotic vehicle 100 through a path within the environment while the robotic vehicle, through a machine-learning process, learns and stores the path for use in task performance and builds and/or updates an electronic map of the environment as it navigates. Intersection behaviors, such as access requests or access release behaviors, may be input by a trainer when an AMR is being trained on a path. The path may be stored for future use and may be updated, for example, to include more, less, or different locations, or to otherwise revise the path and/or path segments, as examples.

As is shown in FIG. 2, in example embodiments, the robotic vehicle 100 includes various functional elements, e.g., components and/or modules, which can be housed within the housing 115. Such functional elements can include at least one processor 10 coupled to at least one memory 12 to cooperatively operate the vehicle and execute its functions or tasks. The memory 12 can include computer program instructions, e.g., in the form of a computer program product, executable by the processor 10. The memory 12 can also store various types of data and information. Such data and information can include route data, path data, path segment data, pick data, location data, environmental data, and/or sensor data, as examples, as well as the electronic map of the environment.

In this embodiment, the processor 10 and memory 12 are shown onboard the robotic vehicle 100 of FIG. 1, but external (offboard) processors, memory, and/or computer program code could additionally or alternatively be provided. That is, in various embodiments, the processing and computer storage capabilities can be onboard, offboard, or some combination thereof. For example, some processor and/or memory functions could be distributed across the supervisor 200, other vehicles, and/or other systems external to the robotic vehicle 100.

The functional elements of the robotic vehicle 100 can further include a navigation module 110 configured to access environmental data, such as the electronic map, and path information stored in memory 12, as examples. The navigation module 110 can communicate instructions to a drive control subsystem 120 to cause the robotic vehicle 100 to navigate its path within the environment. During vehicle travel, the navigation module 110 may receive information from one or more sensors 150, via a sensor interface (UF) 140, to control and adjust the navigation of the robotic vehicle. For example, the sensors 150 may provide sensor data to the navigation module 110 and/or the drive control subsystem 120 in response to sensed objects and/or conditions in the environment to control and/or alter the robotic vehicle's navigation. As examples, the sensors 150 can be configured to collect sensor data related to objects, obstructions, equipment, goods to be picked, hazards, completion of a task, and/or presence of humans and/or other robotic vehicles.

A safety module 130 can also make use of sensor data from one or more of the sensors 150, including LiDAR scanners 154, to interrupt and/or take over control of the drive control subsystem 120 in accordance with applicable safety standard and practices, such as those recommended or dictated by the United States Occupational Safety and Health Administration (OSHA) for certain safety ratings. For example, if safety sensors detect objects in the path as a safety hazard, such sensor data can be used to cause the drive control subsystem 120 to stop the vehicle to avoid the hazard.

The sensors 150 can include one or more stereo cameras 152 and/or other volumetric sensors, sonar sensors, and/or LiDAR scanners or sensors 154, as examples. Inventive concepts are not limited to particular types of sensors. In various embodiments, sensor data from one or more of the sensors 150, e.g., one or more stereo cameras 152 and/or LiDAR scanners 154, can be used to generate and/or update a 2-dimensional or 3-dimensional model or map of the environment, and sensor data from one or more of the sensors 150 can be used for the determining location of the robotic vehicle 100 within the environment relative to the electronic map of the environment.

Examples of stereo cameras arranged to provide 3-dimensional vision systems for a vehicle, which may operate at any of a variety of wavelengths, are described, for example, in U.S. Pat. No. 7,446,766, entitled Multidimensional Evidence Grids and System and Methods for Applying Same and U.S. Pat. No. 8,427,472, entitled Multi-Dimensional Evidence Grids, which are hereby incorporated by reference in their entirety. LiDAR systems arranged to provide light curtains, and their operation in vehicular applications, are described, for example, in U.S. Pat. No. 8,169,596, entitled System and Method Using a Multi-Plane Curtain, which is hereby incorporated by reference in its entirety.

In example embodiments a trainer may employ an AMR's user interface 11 to load behaviors as the trainer trains the AMR to execute a path. The behavior may be associated with entering an intersection when an intersection is encountered along the AMR's training path. Similarly, a trainer may employ the AMR's user interface 11 to load a behavior associated with exiting an intersection when the AMR encounters an exit along the AMR's training path. The locations of intersections may be known to the trainer before training the AMR, may be identified by the trainer as the trainer is training the AMR, or may be delivered to the trainer as the trainer executes the training process, from a processor, such as a supervisory processor, for example.

In example embodiments an entrance behavior may include the AMR's contacting of a processor, such as a supervisory processor, to request access to the intersection in question. That is, during training, the AMR may be trained to execute an intersection entrance behavior that includes requesting access to the intersection from a supervisory processor. In its request the AMR may include information that enables the supervisory processor to determine whether the requesting AMR may have access to the intersection or what type or access the AMR may have to the intersection. Such information may include an AMR identifier, the AMR's path, and the type of travel the AMR is to make through the intersection, for example. The type of travel may include whether the AMR is traveling through the intersection in a straight line or it is altering its travel direction within the intersection. If, for example, the AMR is to turn within the intersection, it may reverse course to make the turn and this reversal may impact the type of access granted to the AMR by the supervisory processor. In some embodiments the behavior may include a fault activity, should the access not be granted for an extended period of time. The fault activity may include contacting the supervisory processor, setting an alarm, providing visual, or other indicia of access failure, for example.

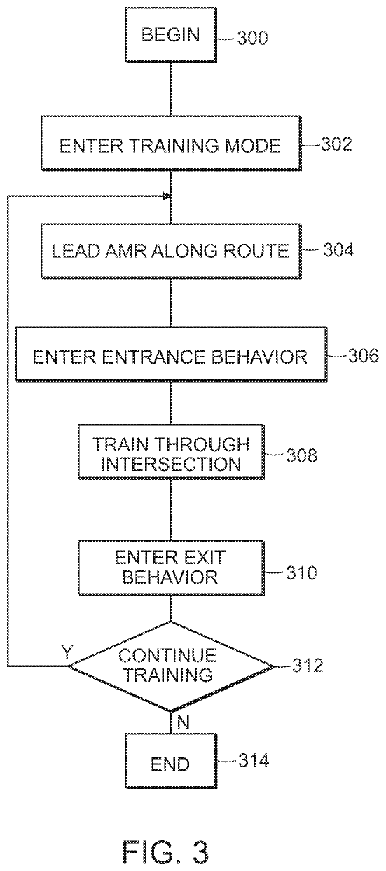

An example process of training an AMR including intersection behaviors in accordance with principles of inventive concepts will be described with reference to the flow chart of FIG. 3. The process begins in step 300 and proceeds to step 302 where a trainer employs a user interface to place the AMR in training mode. From step 302 the process proceeds to step 304 where the trainer leads the AMR along the path it is to follow at run time. As the trainer leads the AMR along the proposed path, if the trainer encounters an intersection the trainer, in step 306, enters an intersection entrance behavior that the AMR is to execute when at the entrance to the intersection. The behavior may include the AMR requesting access to the intersection and awaiting access approval from a supervisory processor, for example. The AMR is trained to proceed through the intersection in step 308 and, in step 310, when an intersection exit is encountered, the trainer enters an intersection exit behavior that the AMR is to execute when departing the intersection. The intersection exit behavior may include contacting a supervisory processor to release its access to the intersection, for example. In step 312 the training/behavior entering process proceeds until the path has been fully trained, whereupon the process proceeds to end in step 314.

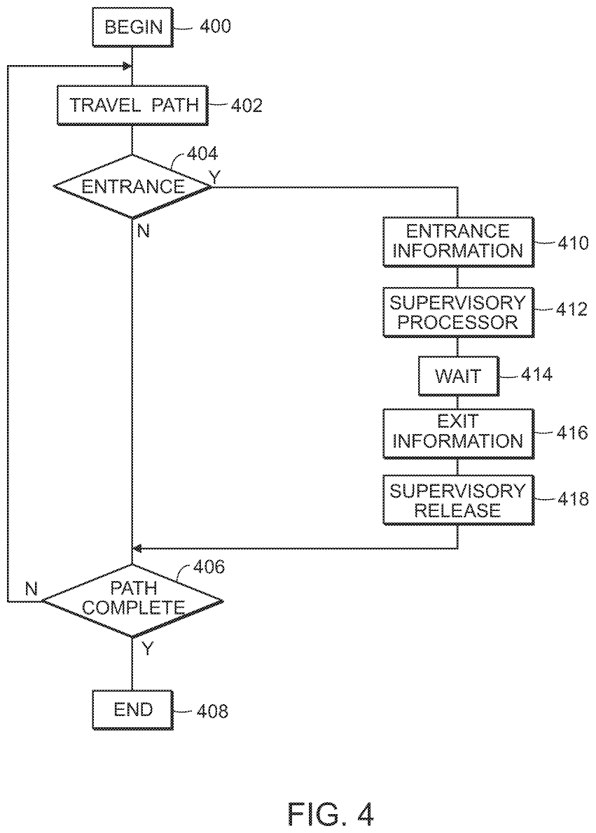

An example process of a trained AMR operating at run time with intersection behaviors in accordance with principles of inventive concepts will be described with reference to the flow chart of FIG. 4. The process begins in step 400 then proceeds to step 402, where the AMR begins travel its trained path. As the AMR travels, it queries whether it has reached an intersection entrance in step 402. The determination of whether the AMR has reached an intersection entrance may be carried out employing the AMR's localization system, sensor suite, or other means, for example. If the AMR has not reached an intersection entrance the process proceeds to step 406, where the AMR determines whether it has reached the end of its path. If it has reached the end of its path it proceeds to end in step 408. If the AMR has not reached the end of its path it returns to step 402 and on to step 404, as previously described. If the AMR determines in step 404 that it has reached an intersection entrance, it proceeds to step 410 where it begins interacting with supervisory processor according to the behavior entered during training. In example embodiments the AMR first requests access to the intersection, providing the supervisory processor with access information, which may include an AMR identifier and the AMR's path information. Path information may include its direction through the intersection, whether it is turning (and therefore stopping) within the intersection, and the AMR's exit location, for example. In response to the AMR's intersection access request, in step 412 the supervisory processor analyzes the AMR's request and the current use of the intersection. Access options are described in greater detail in the discussion related to FIGS. 5 through 8. The AMR awaits its access grant in step 414 and, when received from the supervisory processor, proceeds through the intersection. In some embodiments a timer or other mechanism may be employed by the AMR to determine whether an access delay is an indication of error. If access is delayed beyond a threshold period of time, the AMR may notify the supervisory processor, set an alarm, or otherwise provide notification to the supervisory processor or to warehouse personnel, for example. After receiving access to the intersection the AMR proceeds through the intersection and, when it encounters an intersection exit, it proceeds to execute a trained exit behavior in step 416, which may entail notifying a supervisory processor of its identification, path information, and exit. In response the supervisory processor may, in step 418 modify the status of the intersection to accommodate the next AMR in queue. The process may then return to step 406 and proceed from there as previously described.

FIGS. 5A through 5D illustrate a variety of intersection types that may be encountered in a warehouse application. For the four-way intersection depicted in FIG. 5A multiple AMRs will be allowed within the intersection (dotted lines) only if they are all taking the same route through the intersection. In example embodiments a general process of travel through an intersection may entail an AMR requesting from a supervisory processor access to an intersection as it approaches the intersection. In example embodiments the supervisory processor grants access if there is no other traffic in the intersection. In some cases, if there is other traffic through the intersection but the path of the other traffic does not conflict with the path of the requesting AMR, the supervisory processor may grant access to the requesting AMR. If, for example, the intersection is a four-way intersection (see FIG. 5A, for example) with separate north and south aisles and separate east and west aisles, multiple AMRs may be allowed access to east and west or north and south aisles simultaneously (but not east or west and north or south).

FIG. 5B depicts the route of an AMR turning, reversing into a payload area, for example. In such a situation only AMRs that are traveling straight through the intersection are allowed to multiply occupy the intersection. If an AMR is reversing to take a siding into a payload interaction, only that AMR is allowed within the intersection at one time. The one-lane tunnel of FIG. 5C depicts an intersection where there is not enough space for multiple AMRs to pass one another in opposite directions and, therefore, multiple AMRs will only be allowed within the intersection if they are traveling in the same direction. In the lane staging intersection of FIG. 5D each travel aisle has its own intersection and if an AMR is traveling straight through, another AMR will be allowed within the intersection.

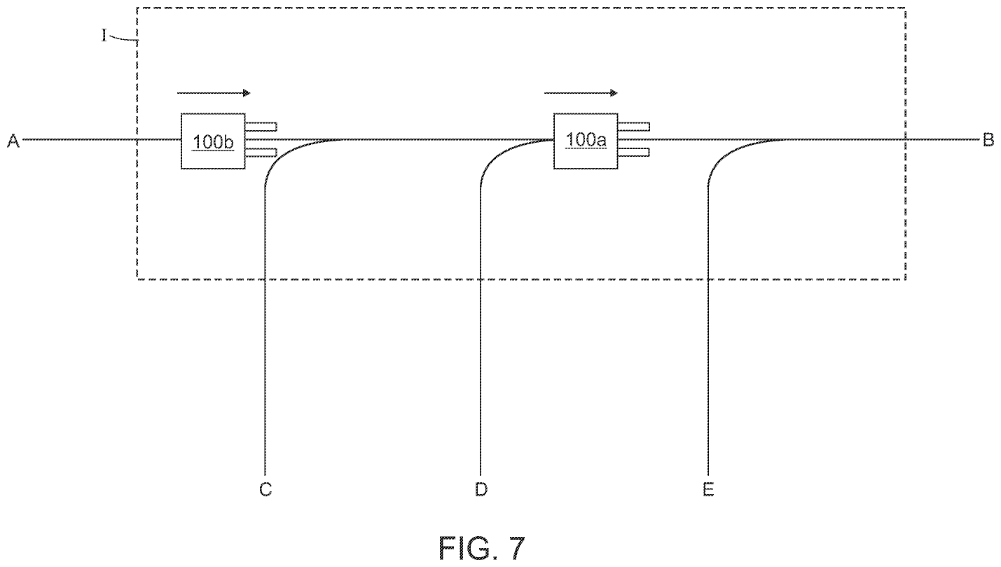

FIGS. 6 and 7 illustrate an example of how a first AMR 100a and a second AMR 100b may interact at an intersection, in accordance with aspects of inventive concepts. In this situation, a first AMR 100a is passing through an intersection I in a forward direction along a path from A to B. The intersection I. indicated by broken line, also includes three additional paths, the path from C to B, the path from D to B, and the path from E to B. Although this example embodiment of an intersection illustrates the merging of four paths, inventive concepts are not limited thereto. In alternative embodiments, a different number of paths: two, three, five or more, may merge.

In the embodiment shown in FIG. 6, a second AMR 100b approaches the intersection I. While outside the intersection I, the second AMR 100b communicates with the server and requests access to the intersection I.

In this situation, the second AMR 100b is also traveling in the forward direction along the path from A to B, so it is granted access to the intersection I, as shown in FIG. 7. As a result, both AMRs travel substantially the same path through intersection I at the same time, and in the same direction. AMR 100b is not instructed to wait outside of the intersection until AMR 100a exits the intersection. Throughput is improved. In example embodiments a supervisory processor may grant access to a requesting AMR if no other AMR sharing a path or a portion of a path through the intersection possesses access to the intersection.

In example embodiments a supervisory processor may grant access to a requesting AMR if another AMR sharing a path or a portion of a path already has non-exclusive access to the intersection.

In example embodiments a supervisory processor may not grant access to a requesting AMR if another AMR sharing a path or a portion of a path through the intersection possesses exclusive or qualified exclusive access to the intersection and the requesting AMR's path through the intersection does not include a turn or other potentially obstructing behavior.

In example embodiments a supervisory processor may grant access to a requesting AMR if another AMR sharing a path or a portion of a path through the intersection possesses qualified exclusive access to the intersection and the qualified exclusive access indicates that the path of the possessing AMR will not obstruct the path of the requesting AMR. The qualified exclusive access may correspond to the AMR's obstructing action distance from the entrance of the intersection and may be given in terms of the number of exits from the entrance, for example. In an example in which three lateral exits are available, such as in the example of FIG. 6, where lateral exits C, D, and E are available. In such cases qualified exclusive access to be granted to AMRs according to the turn/exit their path leads them through, with qualified exclusive access level 3 granted to an AMR that is going to turn out at exit E, qualified exclusive access level 2 granted to an AMR that is going to turn out at exit D, and qualified exclusive access level 1 granted to an AMR that is going to turn out at exit C. Only requesting AMRs with a lower exit level than that of an AMR with an existing qualified exclusive access level may obtain their own qualified exclusive access. As with all accesses, an AMR releases its access when it exits the intersection.

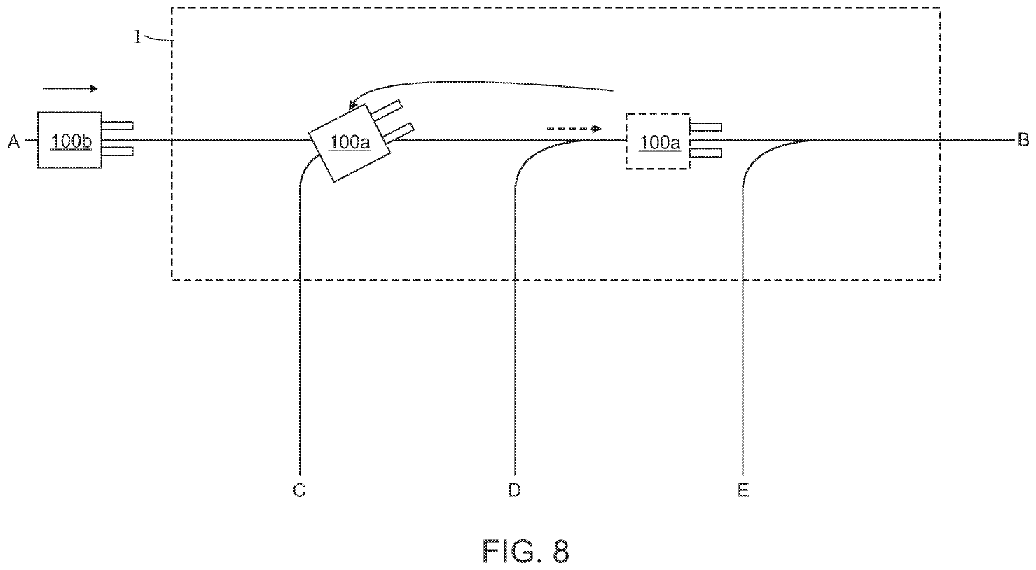

FIG. 8 shows an example of how a first AMR 100a and a second AMR 100b may interact at an intersection, in accordance with aspects of inventive concepts. In this situation, a first AMR 100a enters an intersection I in a first direction (dashed arrow) heading from A to B and then reverses direction to change its path from B to C. In the embodiment shown in FIG. 8, a second AMR 100b approaches the intersection I also traveling in the first direction. While outside the intersection I, the second AMR 100b communicates with the server and requests access to the intersection I.

In this situation, because the first AMR 100a reverses direction the first AMR 100a was granted exclusive access to the intersection I. As a result, the second AMR 100b is denied access to the intersection (instructed by the server to wait) until the first AMR 100a leaves the intersection.

Inventive concepts described herein allow for increased material flow throughout an environment using AMRs, as it allows for multiple AMRs to utilize the same intersection at or near the same time in cases where their paths will not cross. In FIGS. 6-8, the systems and methods involved two AMRs. In alternative embodiments, the system and methods described herein may involve more than two AMRs.

In the examples shown in FIG. 8 a first AMR was granted exclusive access to an intersection if it was traveling in a reverse direction. In some embodiments, exclusive access may be determined by comparing the characteristics of the first AMR with a second AMR. In some embodiments, access may be granted or denied based on the path alignment of the two AMRs. For example, if the second AMR is following the exact same path (in FIG. 6, the path A to B) access may be granted.

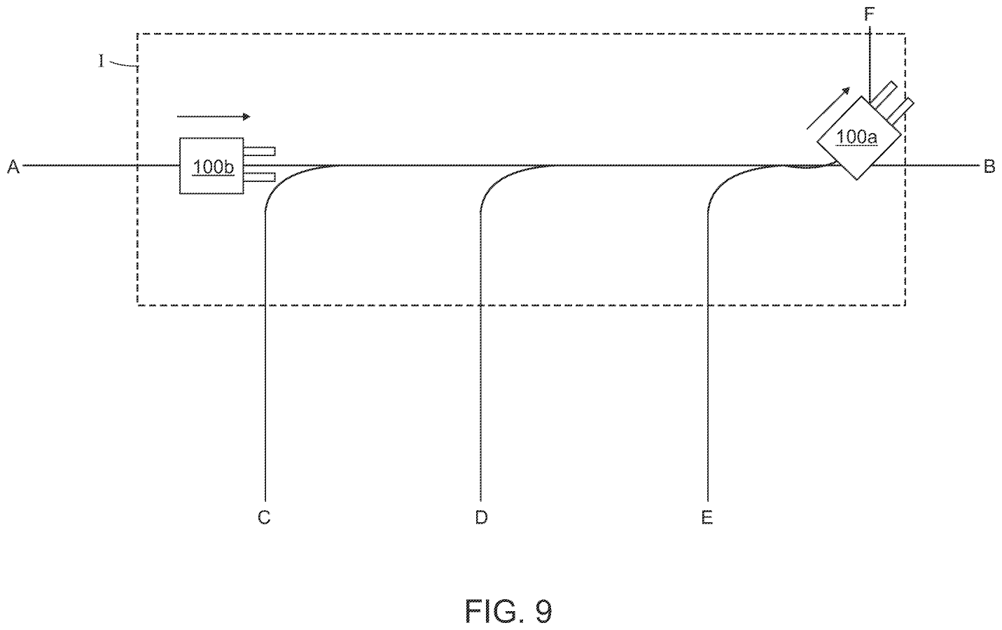

In some embodiments, access may be conditioned on the relative motion of the two AMRs. For example, if the second AMR is following a path from A to B and the first AMR is following a path from A to F, access may be granted to the second AMR because, although they are following different paths, they have overlapping paths and a velocity component in the A-B direction, such as in the embodiment of FIG. 9.

In some embodiments, access to an intersection may be conditioned on there not being any relative motion towards each other. For example, if the first AMR is moving towards the second AMR or the first AMR has a component of its motion that is directed towards the second AMR, the second AMR will be denied access to the intersection. In such embodiments, if the first AMR is moving in a direction orthogonal to the direction of the second AMR, the second AMR may be granted access to the intersection.

In some embodiments, access to an intersection may be conditioned on the distance between the first AMR and the second AMR. In some embodiments, access to an intersection may be conditioned on the speed of the first AMR and the speed of the second AMR. In some embodiments, the system is configured to determine if one or more AMRs have stopped in an intersection and, if an AMR has stopped, this will impact whether additional AMRs will be able to access the intersection.

In some embodiments, access to the intersection can be granted to two or more AMRS if their paths do not overlap within the intersection or if one AMR will have cleared the overlapping portion of their paths before the other AMR navigates the overlapping portion.

In some embodiments, the access decisions are made by a server. In some embodiments, access decisions are made by a warehouse management system. In some embodiments, access requests and decisions are communicated wirelessly. In some embodiments, access decisions are through communication between the affected AMRs. In some embodiments, access decisions may be made through measurements between the affected AMRs.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can be combined in any given way.

Below follows an itemized list of statements describing embodiments in accordance with the inventive concepts:
1. A system, comprising:
an autonomous first agent traveling along a first path through an intersection;
an autonomous second agent traveling along a second path that overlaps the first path in the intersection; and
at least one processor configured to selectively grant or deny the second agent access to the intersection based, at least in part, on the first agent's travel relative to the intersection.
2. The system of statement 1, or any other statement or combination of statements 1 through 12, wherein at least one of the first agent or the second agent is an autonomous mobile robot (AMR).
3. The system of statement 1 or 2, or any other statement or combination of statements 1 through 12, wherein the at least one processor is in communication with at least one computer storage device comprising an intersection management program code executable by the at least one processor.
4. The system of statement 1 or 2, or any other statement or combination of statements 1 through 12, wherein the at least one processor includes a processor configured to selectively grant and deny access to a plurality of AMRs requesting access to the intersection.
5. The system of statement 1 or 2, or any other statement or combination of statements 1 through 12, wherein the at least one processor includes a processor configured to selectively grant the second agent access to the intersection if the first agent does not and/or will not travel in a reverse direction relative to the intersection.
6. The system of statement 1 or 2, or any other statement or combination of statements 1 through 12, wherein the at least one processor includes a processor configured to selectively grant the second agent access to the intersection if the first agent does not and/or will not reverse direction relative to the intersection.
7. The system of statement 1 or 2, or any other statement or combination of statements 1 through 12, wherein the at least one processor includes a processor configured to selectively grant the second agent access to the intersection if the first agent does not and/or will not move towards the second agent in the intersection.
8. The system of statement 1 or 2, or any other statement or combination of statements 1 through 12, wherein the at least one processor includes a processor configured to selectively grant the second agent access to the intersection if the first agent is moving and/or will move at least partially in the same direction as the second agent in the intersection.
9. The system of statement 1 or 2, or any other statement or combination of statements 1 through 12, wherein the at least one processor includes a processor at the first agent configured to communicate with a server configured to grant and deny access to the intersection.
10. The system of statement 1 or 2, or any other statement or combination of statements 1 through 12, wherein the intersection comprises a plurality of paths and/or path segments.
11. The system of statement 1 or 2, or any other statement or combination of statements 1 through 12, wherein the at least one processor includes a processor configured to selectively grant the second agent access to the intersection if the first path is the same or substantially the same as the second path and the first agent and the second agent are moving and/or will move in the same direction relative to the intersection.
12. The system of statement 1 or 2, or any other statement or combination of statements 1 through 12, wherein the at least one processor includes a processor configured to selectively grant the second agent access to the intersection if the first path is the same or substantially the same as the second path and the first agent is not moving and/or will not move in a reverse direction relative to a direction the first agent moved to enter the intersection.
13. A method, comprising:
providing an autonomous first agent;
providing an autonomous second agent;
providing a at least one processor in communication with the first and second agents;
the first agent traveling along a first path through an intersection;
the second agent traveling along a second path; and
the at least one processor selectively granting or denying the second agent access to the intersection based, at least in part, on the first agent's travel relative to the intersection.
14. The method of statement 13, or any other statement or combination of statements 13 through 24, wherein at least one of the first agent or the second agent is an autonomous mobile robot (AMR).
15. The method of statement 13 or 14, or any other statement or combination of statements 13 through 24, further comprising the at least one processor executing an intersection management program code stored at or in least one computer storage device.
16. The method of statement 13 or 14, or any other statement or combination of statements 13 through 24, further comprising the at least one processor selectively granting and/or denying access to a plurality of AMRs requesting access to the intersection.
17. The method of statement 13 or 14, or any other statement or combination of statements 13 through 24, further comprising the at least one processor selectively granting the second agent access to the intersection if the first agent is not and/or will not be traveling in a reverse direction relative to the intersection.
18. The method of statement 13 or 14, or any other statement or combination of statements 13 through 24, further comprising the at least one processor selectively granting the second agent access to the intersection if the first agent does not and/or will not reverse direction relative to the intersection.
19. The method of statement 13 or 14, or any other statement or combination of statements 13 through 24, further comprising the at least one processor selectively granting the second agent access to the intersection if the first agent is not and/or will not be moving towards the second agent in the intersection.
20. The method of statement 13 or 14, or any other statement or combination of statements 13 through 24, further comprising the at least one processor selectively granting the second agent access to the intersection if the first agent does not and/or will not move at least partially in the same direction as the second agent in the intersection.
21. The method of statement 13 or 14, or any other statement or combination of statements 13 through 24, wherein the at least one processor includes a server and the method further comprises the second agent requesting intersection access from the server and the server granting and/or denying the second agent access to the intersection based, at least in part, on the path of the first agent through the intersection.
22. The method of statement 13 or 14, or any other statement or combination of statements 13 through 24, wherein the intersection comprises a plurality of paths and/or path segments.
23. The method of statement 13 or 14, or any other statement or combination of statements 13 through 24, further comprising the at least one processor selectively granting the second agent access to the intersection if the first path is the same or substantially the same as the second path and the first agent and the second agent are moving and/or will move in the same direction relative to the intersection.
24. The method of statement 13 or 14, or any other statement or combination of statements 13 through 24, further comprising the at least one processor selectively granting the second agent access to the intersection if the first path is the same or substantially as the second path and the first agent is not moving and/or will not move in a reverse direction relative to a direction the first agent moved to enter the intersection.

What is claimed is:

1. A system, comprising:
an autonomous first agent traveling along a first path through an intersection;
an autonomous second agent traveling along a second path that overlaps the first path in the intersection; and
at least one processor configured to selectively grant or deny the second agent access to the intersection based, at least in part, on the first agent's travel relative to the intersection.

2. The system of claim 1, wherein at least one of the first agent or the second agent is an autonomous mobile robot (AMR).

3. The system of claim 2, wherein the at least one processor includes a processor configured to selectively grant and deny access to a plurality of AMRs requesting access to the intersection.

4. The system of claim 1, wherein the at least one processor is in communication with at least one computer storage device comprising an intersection management program code executable by the at least one processor.

5. The system of claim 1, wherein the at least one processor includes a processor configured to selectively grant the second agent access to the intersection if the first agent does not and/or will not travel in a reverse direction relative to the intersection.

6. The system of claim 1, wherein the at least one processor includes a processor configured to selectively grant the second agent access to the intersection if the first agent does not and/or will not reverse direction relative to the intersection.

7. The system of claim 1, wherein the at least one processor includes a processor configured to selectively grant the second agent access to the intersection if the first agent does not and/or will not move towards the second agent in the intersection.

8. The system of claim 1, wherein the at least one processor includes a processor configured to selectively grant the second agent access to the intersection if the first agent is moving and/or will move at least partially in the same direction as the second agent in the intersection.

9. The system of claim 1, wherein the at least one processor includes a processor at the first agent configured to communicate with a server configured to grant and deny access to the intersection.

10. The system of claim 1, wherein the intersection comprises a plurality of paths and/or path segments.

11. The system of claim 1, wherein the at least one processor includes a processor configured to selectively grant the second agent access to the intersection if the first path is the same or substantially the same as the second path and the first agent and the second agent are moving and/or will move in the same direction relative to the intersection.

12. The system of claim 1, wherein the at least one processor includes a processor configured to selectively grant the second agent access to the intersection if the first path is the same or substantially the same as the second path and the first agent is not moving and/or will not move in a reverse direction relative to a direction the first agent moved to enter the intersection.

13. A method, comprising:
providing an autonomous first agent;
providing an autonomous second agent;
providing a at least one processor in communication with the first and second agents;
the first agent traveling along a first path through an intersection;
the second agent traveling along a second path; and
the at least one processor selectively granting or denying the second agent access to the intersection based, at least in part, on the first agent's travel relative to the intersection.

14. The method of claim 13, wherein at least one of the first agent or the second agent is an autonomous mobile robot (AMR).

15. The method of claim 14, further comprising the at least one processor selectively granting and/or denying access to a plurality of AMRs requesting access to the intersection.

16. The method of claim 13, further comprising the at least one processor executing an intersection management program code stored at or in least one computer storage device.

17. The method of claim 13, further comprising the at least one processor selectively granting the second agent access to the intersection if the first agent is not and/or will not be traveling in a reverse direction relative to the intersection.

18. The method of claim 13, access to the intersection if the first agent does not and/or will not reverse direction relative to the intersection.

19. The method of claim 13, further comprising the at least one processor selectively granting the second agent access to the intersection if the first agent is not and/or will not be moving towards the second agent in the intersection.

20. The method of claim 13, further comprising the at least one processor selectively granting the second agent access to the intersection if the first agent does not and/or will not move at least partially in the same direction as the second agent in the intersection.

21. The method of claim 13, wherein the at least one processor includes a server and the method further comprises the second agent requesting intersection access from the server and the server granting and/or denying the second agent access to the intersection based, at least in part, on the path of the first agent through the intersection.

22. The method of claim 13, wherein the intersection comprises a plurality of paths and/or path segments.

23. The method of claim 13, further comprising the at least one processor selectively granting the second agent access to the intersection if the first path is the same or substantially the same as the second path and the first agent and the second agent are moving and/or will move in the same direction relative to the intersection.

24. The method of claim 13, further comprising the at least one processor selectively granting the second agent access to the intersection if the first path is the same or substantially as the second path and the first agent is not moving and/or will not move in a reverse direction relative to a direction the first agent moved to enter the intersection.
